(19) United States
(12) Patent Application Publication
(10) Pub. No.: US 2024/0006102 A1
(43) Pub. Date: Jan. 4, 2024

(54) MAGNETIC BODY AND MAGNETIC ELEMENT

(71) Applicant: TOKIN Corporation, Sendai-shi, Miyagi (JP)

(72) Inventors: Satoru MATSUZAWA, Sendai-shi, Miyagi (JP); Akiko OSHIMA, Sendai-shi, Miyagi (JP); Koichi OKAMOTO, Sendai-shi, Miyagi (JP)

(21) Appl. No.: 18/252,701

(22) PCT Filed: Jul. 15, 2021
(86) PCT No.: PCT/JP2021/026558

§ 371 Date: May 11, 2023

(30) Foreign Application Priority Data
Nov. 30, 2020 (JP) 2020-197987

(51) Int. Cl. H01F 1/147; H01F 27/255; B22F 1/16; B22F 1/05; B22F 9/04; B22F 1/145; B22F 1/102; B22F 5/10; B22F 3/02; C22C 38/34

(52) U.S. Cl. CPC H01F 1/14766; H01F 27/255; B22F 1/16; B22F 1/05; B22F 9/04; B22F 1/145; B22F 1/102; B22F 5/106; B22F 3/02; C22C 38/34; B22F 2301/35; B22F 2304/10; B22F 2998/10; B22F 2999/00; C22C 2202/02

(57) ABSTRACT

Provided is a magnetic body and a magnetic element that can be used in a high temperature environment of 180° C. and are excellent in heat resistance. The magnetic body according to an aspect of the present invention includes an iron alloy powder having an inorganic insulating layer on the surface thereof and a resin cured product, and contains 4 to 10 parts by mass of Si in 100 parts by mass of the iron alloy powder.

### TECHNICAL FIELD

The present invention relates to a magnetic body and a magnetic element.

### BACKGROUND ART

In recent years, the demand for in-vehicle electronic components is increasing with the electrification of automobiles. In addition, in order to secure the space inside the vehicle, electronic components are arranged near the engine and motor, and there is a demand for further improvement in heat resistance. Magnetic elements used in electronic components are also required to have higher heat resistance. In addition, long-term heat resistance in a high temperature environment of 180° C. and maintenance of strength of the element against long-term vibration are required in order to ensure the function of the inductor for a long period of time.

A so-called plastic magnet is one example of a magnetic body used for a magnetic element. The plastic magnet is a magnet formed by molding a binder resin in which soft magnetic metal powder is dispersed into a predetermined shape by injection molding or the like. The plastic magnet relatively easily provides a magnetic body having a desired shape.

As one method for improving the heat resistance of a magnetic body, selection of a binder resin with excellent heat resistance has been investigated. For example, Patent Literature 1 discloses a magnetic core using a composite fluororesin containing a perfluoro fluororesin having excellent heat resistance.

In addition, it has been investigated to produce an integrated magnetic element in which a coil is embedded in a magnetic body by using a plastic magnet. For example, Patent Literature 2 discloses a method for producing an inductor in which a coil is arranged in a cavity and then the cavity is filled with a composition containing a thermoplastic resin element and magnetic powder. An integrally molded inductor also has the advantage of being able to suppress leakage magnetic flux without shielding.

### CITATION LIST

### Patent Literature

Patent Literature 1: Japanese Unexamined Patent Application Publication No. 2017-188680
Patent Literature 2: Japanese Unexamined Patent Application Publication No. 2019-102713

### SUMMARY OF INVENTION

### Technical Problem

The magnetic core using the magnetic material of Patent Literature 1 is said to have heat resistance of 260° C. Meanwhile, when processing the magnetic material of Patent Literature 1, it is necessary to process the magnetic material at a temperature exceeding the melting point of the perfluoro fluororesin. From the viewpoint of production, the magnetic material of Patent Literature 1 is problematic in that in the form of an inductor containing a coil, the coil and terminal portions cannot withstand processing at a temperature exceeding the melting point of the perfluoro fluororesin, inevitably leading to deterioration in insulation of the coil covering, and oxidation of the terminal portions. In addition, in order to function as an inductor when arranged around an engine or motor, it is important not only to insulate the magnetic body and the coil, but also to ensure insulation between terminals. In addition, it is necessary to secure the strength of the element because the electronic device in the automobile is subjected to vibration over a long period of time.

From the viewpoint of processability during production, energy saving and the like, it is desirable to process the magnetic material at a lower temperature. In addition, when producing an integrated magnetic element as in Patent Literature 2, coils and coil terminals are required to have heat resistance against the temperature during processing of magnetic materials, thus requiring lower processing temperatures for magnetic materials.

In view of the above problem, an object of the present invention is to provide a magnetic body and a magnetic element having excellent long-term heat resistance in a high temperature environment of 180° C.

### Solution to Problem

The magnetic body according to an aspect of the present invention includes an iron alloy powder having an inorganic insulating layer on the surface thereof and a resin cured product, and contains 4 to 10 parts by mass of Si in 100 parts by mass of the iron alloy powder.

The magnetic element according to an aspect of the present invention includes the magnetic body and a coil embedded in the magnetic body.

### Advantageous Effects of Invention

The present invention can provide a magnetic body and a magnetic element having excellent long-term heat resistance in a high temperature environment of 180° C.

### BRIEF DESCRIPTION OF DRAWINGS

FIG. 1 is a schematic transparent view of a magnetic element according to an embodiment of the present invention.

FIG. 2 is a schematic cross-sectional view showing the I-I cross section of FIG. 1.

FIG. 3 is a graph showing changes over time in insulation resistance in heat resistance evaluation of magnetic bodies of Examples and Comparative Examples.

FIG. 4 is a graph showing changes in weight over time in heat resistance evaluation of magnetic bodies of Examples and Comparative Examples.

### DESCRIPTION OF EMBODIMENTS

Hereinafter, the magnetic body and the magnetic element according to the present invention will be described in detail in order.

In addition, unless otherwise specified, “−” indicating a numerical range includes the lower limit value and the upper limit value thereof.

### [Magnetic Body]

The magnetic body according to the present embodiment (hereinafter also referred to as the present magnetic body) includes an iron alloy powder having an inorganic insulating layer on the surface thereof and a resin cured product, and contains 4 to 10 parts by mass of Si in 100 parts by mass of the iron alloy powder.

The present magnetic body has excellent long-term heat resistance in a high temperature environment of 180° C. due to a combination of an iron alloy powder containing a specific amount of Si, an inorganic insulating layer coating the iron alloy powder, and a resin cured product. The reason for this is partially unclear, but the present inventors presume as follows.

It is presumed that using an iron alloy powder containing 4 to 10 parts by mass of Si not only suppresses the oxidation of the iron alloy powder itself in a high-temperature environment, but also suppresses the catalytic action of iron generated at the contact surface between the iron and the resin cured product, thereby suppressing the thermal oxidative decomposition of the resin cured product. In addition, the iron alloy powder has an inorganic insulating layer, and therefore contact between the iron alloy powders is suppressed and insulation is retained, and contact with the resin cured product is further suppressed, resulting in reduced oxidation of the resin cured product. It is presumed from these results that the above constitution of the present magnetic body suppresses thermal oxidation of the resin cured product in particular, resulting in the fact that high insulation resistance and mechanical strength in a high temperature environment of about 180° C. are retained.

The present magnetic body includes at least an iron alloy powder having an inorganic insulating layer, and a resin cured product, and may further have other components within a range that does not impair the effects of the present invention. Each constitution of the present magnetic body will be described below.

### <Iron Alloy Powder>

In the present magnetic body, the iron alloy powder contains 4 to 10 parts by mass of Si in 100 parts by mass of the iron alloy powder. Containing Si results in the soft magnetic powder having a relatively high magnetic permeability. Furthermore, in the present embodiment, containing 4 parts by mass or more of Si can suppress the oxidation of the iron alloy powder and thermal decomposition of the resin cured product. From the viewpoint of the heat resistance of the magnetic body, the Si content in 100 parts by mass of the iron alloy powder is preferably 4.5 parts by mass or more, more preferably 5 parts by mass or more. Meanwhile, the effect of suppressing thermal decomposition is sufficient when the Si content is 10 parts by mass or less in 100 parts by mass of the iron alloy powder. Setting the Si content to 10 parts by mass or less, preferably 8 parts by mass or less, more preferably 7 parts by mass or less can not only suppress deterioration of magnetic properties, but also suppress hardness and brittleness of the iron alloy powder, and further provide excellent handleability during processing.

The iron alloy powder may further contain other elements as long as the effects of the present invention are exhibited. Other elements include Cr, Al, Mn, Ni, C, O, N, S, P, B, and Cu. From the viewpoint of heat resistance, the iron alloy powder preferably contains one or more selected from Cr and Al. Cr and Al form a passive layer on the surface of the iron alloy powder, thus suppressing the oxidation of the iron alloy powder in a high temperature environment, and further suppressing contact between the resin cured product and iron to suppress the oxidation of the resin cured product.

The proportion of Cr or Al in the iron alloy powder is preferably 0.5 to 10 parts by mass, more preferably 3 to 8 parts by mass in 100 parts by mass of the iron alloy powder, from the viewpoint of heat resistance and rust prevention. When both Cr and Al are contained, the total mass is preferably within the above range.

The total content of elements other than Cr and Al is preferably 1 part by mass or less, preferably 0.5 parts by mass or less in 100 parts by mass of the iron alloy powder, from the viewpoint of heat resistance and magnetic properties.

Examples of the shape of the iron alloy powder include spherical, oval, needle, rod, and plate. The spherical shape is preferable from the viewpoint of filling the mold when molding the present magnetic body and reducing the contact area with the resin cured product and the like.

In addition, the average particle size of the iron alloy powder is preferably 1 to 100 μm, more preferably 3 to 60 μm, from the viewpoint of heat resistance. Furthermore, from the viewpoint of the skin effect in use in a frequency band of 1 MHz or more, the average particle size is more preferably 5 to 30 μm.

The method for producing the iron alloy powder is not particularly limited, and may be appropriately selected from known methods such as an atomizing method, a melt spinning method, a rotating electrode method, a mechanical alloying method, and a chemical deposition method by reduction. The atomizing method is preferable because spherical-shaped particles can be suitably obtained. Examples of the atomizing method include a gas atomizing method, a water atomizing method, a centrifugal force atomizing method, and a plasma atomizing method. The gas atomizing method or the water atomizing method is preferable from the viewpoint of mass production stability and productivity, and the water atomizing method is preferable from the viewpoint of easily obtaining a powder of 30 μm or less.

### <Inorganic Insulating Layer>

The iron alloy powder includes an inorganic insulating layer on the surface thereof. Including the inorganic insulating layer not only suppresses contact between the iron alloy powders to ensure insulation, but also suppresses contact between the iron alloy powder and the resin cured product to suppress thermal decomposition of the resin cured product. In addition, using an inorganic insulating layer provides the insulating layer with excellent heat resistance.

Examples of the inorganic insulating layer include: an inorganic oxide such as SiO₂ (silicic acid), Al₂O₃ (alumina), and ZrO₂; a nitride such as Si₃N₄ and BN; a glass material such as silicate glass, borate glass, borosilicate glass, phosphate glass, and bismuth glass; and a mineral such as mica and clay. Of these, it is preferable to contain a phosphate salt and a silicate salt. The insulating material in the inorganic insulating layer can be used singly or in combination of two or more.

From the viewpoint of ensuring insulation resistance and suppressing oxidation of the resin cured product, the inorganic insulating layer accounts for preferably 0.1 parts by mass or more, more preferably 0.3 parts by mass or more, and still more preferably 0.5 parts by mass or more relative to 100 parts by mass of the iron alloy powder. The inorganic insulating layer may account for 3 parts by mass or less relative to 100 parts by mass of the iron alloy powder, preferably 2.5 parts by mass or less, more preferably 2.0 parts by mass or less from the viewpoint of magnetic properties.

The average thickness of the inorganic insulating layer is preferably 10 to 100 nm, more preferably 10 to 60 nm, from the viewpoint of ensuring insulation resistance and suppressing the oxidation of the resin cured product.

The thickness of the inorganic insulating layer can be determined by observing the metal powder surface with a transmission electron microscope (TEM). In addition, for simplicity, assuming that the metal powder is spherical particles with a single particle size, and using the specific surface area of the metal powder and the specific gravity of the insulating material, the average thickness of the inorganic insulating layer can be calculated from the following formulae (1) and (2).

Specific surface area of metal powder (m²/g)=6/[specific gravity of metal powder (g/m³)×particle size of metal powder (m)] Formula (1):

Inorganic insulating layer thickness (m)=mass of insulating material (g)/[mass of metal powder (g)×specific surface area of metal powder (m²/g)×specific gravity of coating powder (g/m³)] Formula (2):

The method of providing the inorganic insulating layer on the iron alloy powder can be appropriately selected from, for example, a powder mixing method, an immersion method, a sol-gel method, a CVD method, a PVD method, or other known methods.

### <Resin Cured Product>

The present magnetic body includes a resin cured product. The resin cured product is a cured product of a resin used as a binder component. The resin may have curability due to a single component or a plurality of components, and examples thereof include a thermosetting resin and a photocurable resin. The curable resin in the present magnetic body is preferably a thermosetting resin from the viewpoint of achieving both processability during heat molding and heat resistance after production. In the present invention, the resin cured product refers to a product in which at least a part of a curable resin has undergone a crosslinking reaction.

From the viewpoint of heat resistance, the resin cured product preferably has polyesterimide in the molecule. In the present invention, polyesterimide refers to one having two or more ester bonds and two or more imide bonds in the molecule. The resin cured product having polyesterimide has a three-dimensional structure in which a plurality of polymer chains are crosslinked, and the resin cured product has a plurality of ester bonds and imide bonds, thereby stabilizing the structure, and further suppressing thermal decomposition in a high temperature environment of 180° C.

For this reason, the thermosetting resin, which is the precursor of the resin cured product, is preferably one that forms a cured product containing a polyesterimide structure after curing. In particular, a thermosetting resin composition containing a polyester resin, an epoxy resin, and a polyimide resin is preferable because the present magnetic body can be easily molded at a low temperature. Using the thermosetting resin composition can set the heating temperature during molding to, for example, about 180° C.

The polyester resin can be appropriately selected and used from polymers of polycarboxylic acid and polyol. In particular, a polyester resin having a carboxyl group is preferable from the viewpoint of reactivity with the epoxy resin.

The polycarboxylic acid can be appropriately selected from compounds having two or more carboxylic acids in one molecule, and in particular, a dicarboxylic acid having two carboxylic acids in one molecule or an anhydride thereof is preferable.

Specific examples of the dicarboxylic acid include terephthalic acid, isophthalic acid, naphthalene dicarboxylic acid, succinic acid, adipic acid, and maleic acid, and these can be used singly or in combination of two or more. In the present invention, the polycarboxylic acid preferably contains one or more selected from isophthalic acid and maleic acid.

The polyol can be appropriately selected from a compound having two or more hydroxy groups in one molecule. Specific examples of the polyol include ethylene glycol, propylene glycol, 1,4-butanediol, 1,5-pentanediol, 1,6-hexanediol, 2-methyl-1,3-propanediol, 3-methyl-1,5-pentanediol, diethylene glycol, dipropylene glycol, neopentyl glycol, 1,3-butanediol, trimethylpropane, glycerin, 1,4-cyclohexanediol, cyclohexanedimethanol, bisphenol A, and bisphenol F, and these can be used singly or in combination of two or more.

The polyester resin can be obtained by subjecting the above polycarboxylic acid and polyol to a dehydration condensation reaction by a known method. In addition, the commercially available product having a desired structure may be used.

The epoxy resin can be appropriately selected from a compound having one or more epoxy groups in one molecule. Suitable specific examples of the epoxy resin include an epibis epoxy resin obtained by condensation reaction of epichlorohydrin, bisphenol A, bisphenol F, and alkylene oxide-modified products thereof; a novolac-based epoxy resin obtained by condensation reaction of epichlorohydrin and a phenolic resin; and an alkyl glycidyl ether such as methyl glycidyl ether and butyl glycidyl ether, and these can be used singly or in combination of two or more.

The polyimide resin may be appropriately selected from a compound having two or more imide bonds in one molecule. In particular, those having an ethylenic double bond are preferable from the viewpoint of crosslinkability with other resins, and N,N′-(4,4′-diphenylmethane)diallylnadiimide and N,N′-(m-xylylene)diallylnadimide are preferable. The polyimide resin may be used singly or in combination of two or more.

From the viewpoint of the heat resistance and mechanical strength of the resin cured product obtained, the blending ratio of the thermosetting resin composition is preferably 20 to 50 parts by mass of the polyester resin, 1 to 25 parts by mass of the epoxy resin, and 1 to 15 parts by mass of the polyimide resin.

The thermosetting resin composition may further contain other components. Examples of the other component include a vinyl-based monomer, an epoxy acrylate, a curing agent, and a catalyst.

Examples of the vinyl-based monomer include a monomer having a vinyl group, (meth)acryloyl group, and the like, and examples thereof include: a vinyl-based monomer such as vinyl acetate and styrene; and an acrylic monomer such as methyl (meth)acrylate. The (meth)acryloyl group represents an acryloyl group or a methacryloyl group, and the same applies to (meth)acrylate. Examples of the epoxy acrylate include a compound obtained by reacting epoxy groups of various epoxy resins with carboxyl groups of (meth)acrylic acid.

A peroxide is preferable as a curing agent for promoting the curing reaction of the thermosetting resin composition. Specific examples of the peroxide include dicumyl peroxide, 2,5-dimethyl-2,5-di(benzoylperoxy)hexane, 2,2-bis(tert-butyldioxy)octane, t-butylperoxatate, dicumyl peroxide, 2,5-dimethyl-2,5-di(t-butylperoxy)hexane, α,α′-bis(t-butylperoxy-m-isopropyl)benzene, t-butyl-cumyl-peroxide, di-t-butyl-peroxide, 2,5-dimethyl, and 2,5-di(t-butylperoxy)hexane-3.

In addition, imidazole, tertiary amines, and the like can be used as a reaction catalyst between a carboxyl group and an epoxy group.

When blending a vinyl-based monomer or epoxy acrylate in a thermosetting resin composition, the blending ratio is preferably such that the ratio between the total mass of the polyester resin, the epoxy resin, and the polyimide resin and the total mass of the vinyl-based monomer and the epoxy acrylate is 1:3 to 3:1.

The present magnetic body can be obtained, for example, by dispersing the iron alloy powder having the insulating layer in the thermosetting resin composition, filling a mold having a desired shape with the mixture, and heating the mixture. The heating conditions depend on the reactivity of the thermosetting resin composition, and for example, heating at 150 to 200° C. for about 0.5 to 12 hours allows the crosslinking reaction to proceed sufficiently. In addition to an ester bond and an imide bond, a hydroxy group derived from the reaction between an epoxy group and a carboxy group is detected in the resin cured product obtained by curing the thermosetting resin composition.

The blending ratio of the thermosetting resin composition and the iron alloy powder may be appropriately adjusted depending on the application and the like, and for example, is preferably 1 to 10 parts by mass, more preferably 2 to 6 parts by mass relative to 100 parts by mass of the iron alloy powder. With the blending ratio equal to or more than the above lower limit value, the mechanical strength of the magnetic body is improved. With the blending ratio equal to or less than the above upper limit value, the magnetic properties are excellent.

The present magnetic body can retain an insulation resistance of 10⁷Ω or more and a radial crushing strength of 30 MPa or more, preferably 50 MPa or more, for example, after being held in an environment of 180° C. for 1000 hours, exhibiting excellent long-term storage stability in a high temperature environment.

The present magnetic body can be used for known applications in which magnetic bodies are used. This magnetic body has excellent long-term heat resistance in a high temperature environment of 180° C., and therefore can be suitably used as a core material for in-vehicle applications that require heat resistance in particular, particularly inductors placed near engines.

In addition, the present magnetic body can be heat-treated at a relatively low temperature of about 180° C. during molding, and therefore can be suitably used for a coil-embedded magnetic element, which will be described below.

### [Magnetic Element]

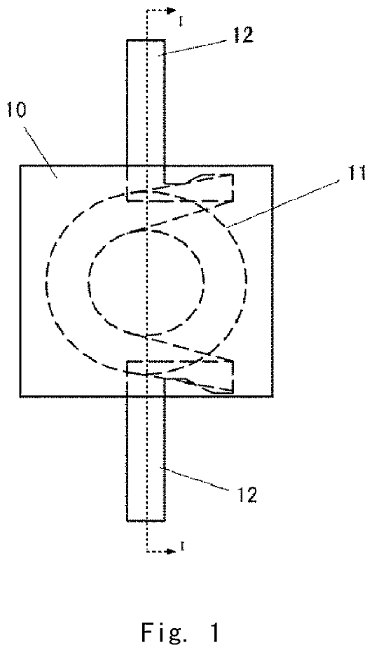

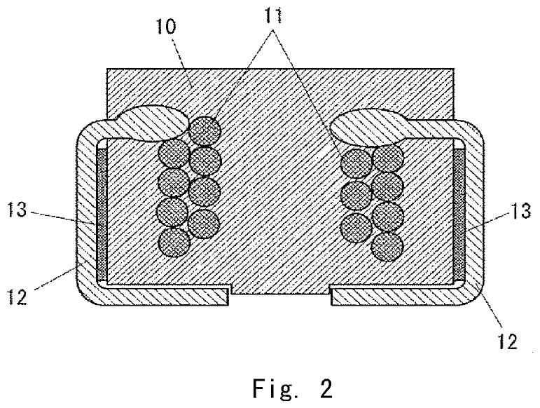

An example of the magnetic element (also referred to as the present magnetic element) according to the present invention will be described with reference to FIGS. 1 and 2. FIG. 1 is a schematic top transparent view of a magnetic element, and FIG. 2 is a schematic cross-sectional view taken along line I-I of FIG. 1. The terminal portion 12 in FIG. 1 is bonded to a magnetic body 10 using an adhesive member 13 in FIG. 2. The present magnetic element has the magnetic body 10 and a coil 11 embedded in the magnetic body 10, and the magnetic body 10 is the magnetic body according to the present invention. In the present magnetic element, at least the winding portion of the coil 11 is embedded in the magnetic body 10, and a part of the coil 11 may be exposed from the magnetic body 10. For example, a terminal portion 12 is made of copper plated with Sn or the like from the viewpoint of wettability of lead-free solder or the like. The copper of the terminal portion 12 may be joined with the coil 11 or may be integrated.

The shape of the coil 11 is appropriately selected from known coils used in magnetic elements, and typically, it has a winding portion and a terminal portion to be connected to a circuit or the like. The material of the coil 11 is not particularly limited, and may be, for example, a copper wire or the like, and the copper wire preferably has an insulating film. The insulating film is preferably a polyamideimide film, a polyimide film, or the like from the viewpoint of heat resistance.

When producing a coil-embedded magnetic element, the coil may be arranged in the mold before or during the filling of the mold with the magnetic body in the method for producing the magnetic body.

In addition, although not shown, a magnetic element produced by winding a coil around the present magnetic body also has excellent long-term heat resistance in a high temperature environment of 180° C.

The present magnetic element can be suitably used as an inductor used in power inductors, choke coils, transformers, and the like.

### EXAMPLES

Hereinafter, the present invention will be described in more detail with reference to Examples and Comparative Examples. In addition, these descriptions do not limit the present invention.

### Example 1

As the iron alloy powder, there was prepared an iron alloy powder having an average particle size of 10 μm and containing 4.5 to 7 parts by mass of Si and 3 to 8 parts by mass of Cr in 100 parts by mass of the iron alloy powder.

The iron alloy powder was coated with a phosphoric acid-based inorganic insulating material equivalent to 0.5 parts by mass relative to 100 parts by mass of the iron alloy powder to form an insulating layer (the thickness of the insulating layer is about 10 nm). To the iron alloy powder having the insulating layer, the following thermosetting resin composition (1) equivalent to 5 parts by mass relative to 100 parts by mass of the iron alloy powder was added and kneaded to obtain an iron alloy powder coated with the thermosetting resin composition (1). The thermosetting resin composition (1) was a composition containing a polyester-based resin, an epoxy-based resin, and a polyimide-based resin.

The iron alloy powder after the above treatment was passed through a metal mesh of 500 μm, and granulated by adjusting the particle size so as to be easily filled into a mold. The granulated powder was filled in a ring-shaped mold having an outer diameter of 13 mm and an inner diameter of 8 mm, and was pressure-molded at a molding pressure of 5 ton/cm². The resulting ring-shaped sample was thermoset at 180° C. for 2 hours or more in a constant temperature bath to obtain a magnetic body of Example 1 containing a resin cured product containing polyesterimide.

### Example 2

A magnetic body of Example 2 was obtained in the same manner as in Example 1, except that the amount of the phosphoric acid-based inorganic insulating material was changed to 1.5 parts by mass in Example 1 (the thickness of the insulating layer was about 50 nm).

### Example 3

A magnetic body of Example 3 was obtained in the same manner as in Example 1, except that the amount of the phosphoric acid-based inorganic insulating material was changed to 1.5 parts by mass and the amount of the thermosetting resin composition (1) was changed to 2 parts by mass in Example 1.

### Example 4

A magnetic body of Example 4 was obtained in the same manner as in Example 1, except that the thermosetting resin composition in Example 1 was changed to a thermosetting phenolic resin.

### Comparative Example 1

A magnetic body of Comparative Example 1 was obtained in the same manner as in Example 1, except that the insulating coating treatment was not performed in Example 1.

### Comparative Example 2

A magnetic body of Comparative Example 2 was obtained in the same manner as in Comparative Example 1, except that the thermosetting resin composition in Comparative Example 1 was changed to a thermosetting phenolic resin.

### Comparative Example 3

A magnetic body of Comparative Example 3 was obtained in the same manner as in Comparative Example 1, except that the thermosetting resin composition in Comparative Example 1 was changed to an epoxy resin having a glass transition temperature of 250° C. or more.

### Example 5

A magnetic body of Example 5 was obtained in the same manner as in Example 1, except that 0.5 parts by mass of the phosphoric acid-based inorganic insulating material was changed to 1 part by mass of the silicic acid-based insulating material, and the thermosetting resin composition was changed to a thermosetting phenolic resin in Example 1 (the thickness of the insulating layer was about 30 nm).

### Example 6

A magnetic body of Example 6 was obtained in the same manner as in Example 5, except that the iron alloy powder was changed to an iron alloy powder containing 6.5 parts by mass of Si in 100 parts by mass of the iron alloy powder and having an average particle size of 10 μm in Example 5.

### Comparative Example 4

As the iron alloy powder, there was prepared an iron alloy powder having an average particle size of 10 μm and containing 0.5 parts by mass of Si and 1 part by mass of Cr in 100 parts by mass of the iron alloy powder. The iron alloy powder was coated with a silicic acid-based inorganic insulating material equivalent to 1 part by mass relative to 100 parts by mass of the iron alloy powder to form an insulating layer (the thickness of the insulating layer was about 30 nm). To the iron alloy powder having the insulating layer, the thermosetting phenolic resin equivalent to 5 parts by mass relative to 100 parts by mass of the iron alloy powder was added and kneaded to obtain an iron alloy powder coated with the resin composition.

Subsequent steps were performed in the same manner as in Example 1 to obtain a magnetic body of Comparative Example 4.

Table 1 shows the constitution of each magnetic body.

TABLE 1
Constitution of magnetic body

| | | Inorganic insulating layer | | | Resin cured product | |
|---|---|---|---|---|---|---|
| | Iron alloy | | Amount coated relative | | | Amount added relative |
| | powder | | to 100 parts by mass | | | to 100 parts by mass |
| | Si proportion | Insulating | of iron alloy powder | Thickness | | of iron alloy powder |
| | (% by mass) | material | (parts by mass) | (nm) | Resin | (parts by mass) |
| Example 1 | 4.5 to 7 | Phosphate- | 0.5 | 10 | Thermosetting resin | 5 |
| | | based insulating | | | composition (1) | |
| | | material | | | | |
| Example 2 | 4.5 to 7 | Phosphate- | 1.5 | 50 | Thermosetting resin | 5 |
| | | based insulating | | | composition (1) | |
| | | material | | | | |
| Example 3 | 4.5 to 7 | Phosphate- | 1.5 | 50 | Thermosetting resin | 2 |
| | | based insulating | | | composition (1) | |
| | | material | | | | |
| Example 4 | 4.5 to 7 | Phosphate- | 0.5 | 10 | Thermosetting phenolic | 5 |
| | | based insulating | | | resin | |
| | | material | | | | |
| Comparative | 4.5 to 7 | — | | | Thermosetting resin | 5 |
| Example 1 | | | | | composition (1) | |
| Comparative | 4.5 to 7 | — | | | Thermosetting phenolic | 5 |
| Example 2 | | | | | resin | |
| Comparative | 4.5 to 7 | — | | | Epoxy resin | 5 |
| Example 3 | | | | | | |
| Example 5 | 4.5 to 7 | Silicic acid- | 1.0 | 30 | Thermosetting phenolic | 5 |
| | | based insulating | | | resin | |
| | | material | | | | |
| Example 6 | 6.5 | Silicic acid- | 1.0 | 30 | Thermosetting phenolic | 5 |
| | | based insulating | | | resin | |
| | | material | | | | |
| Comparative | 0.5 | Silicic acid- | 1.0 | 30 | Thermosetting phenolic | 5 |
| Example 4 | | based insulating | | | resin | |
| | | material | | | | |

“—” indicates no inorganic insulating layer.

### <Evaluation of Magnetic Body>

The magnetic bodies of Examples and Comparative Examples were evaluated by the following method.

The density was obtained by measuring the outer diameter, inner diameter, and height of the ring-shaped magnetic body obtained above with a vernier caliper, and calculating the apparent density from the volume and weight.

Magnetic permeability was measured by winding 10 turns of copper wire around a ring-shaped magnetic body with an outer diameter of 13 mm and an inner diameter of 8 mm, and measuring the initial magnetic permeability at a frequency of 1 MHz using an impedance analyzer.

The insulation resistance of the magnetic body was measured with an insulation resistance meter by applying electrodes with a diameter of 1 mm to the top and bottom surfaces of the magnetic body.

The strength of the magnetic body was evaluated by performing a compression test in accordance with the test method for radial crushing strength of JIS Z2507 and calculating the radial crushing strength from the formula (3).

K=[F×(D−e)]/(L×e²) : Formula (3)

K: Radial crushing strength (MPa)

F: Maximum breaking load (N)

L: Length of hollow cylinder (mm)

D: Outer diameter of hollow cylinder (mm)

e: Wall thickness of hollow cylinder (mm)

### (Heat Resistance Evaluation)

The heat resistance was evaluated by storing each of the magnetic bodies of Examples and Comparative Examples in the atmosphere at 180° C. and measuring the insulation resistance and radial crushing strength after 1000 hours in the same manner as described above. In Examples 5 and 6 and Comparative Example 4, only insulation resistance was measured. The results are shown in Tables 2 to 6. The strength retention rate was calculated by (radial crushing strength after standing for 1000 hours)/(radial crushing strength immediately after production)×100(%).

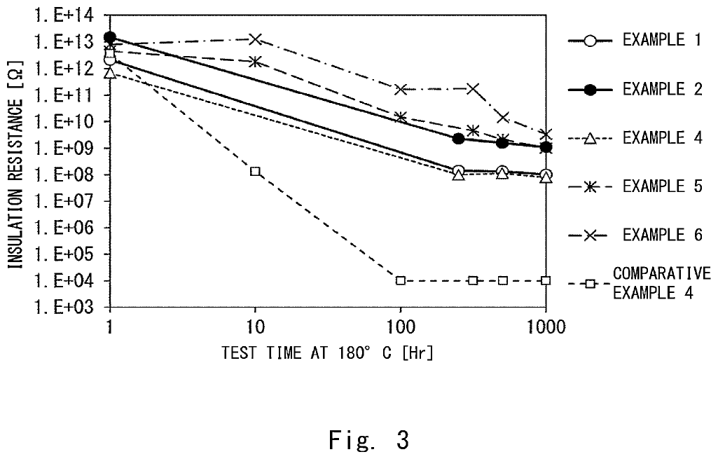

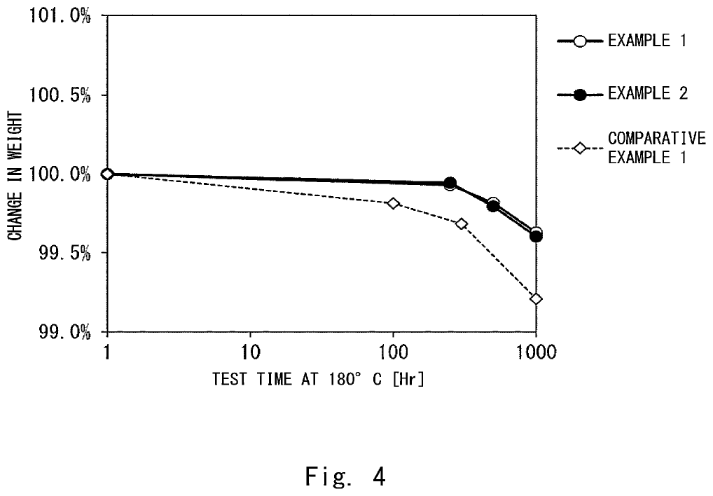

For the magnetic bodies of Examples 1 to 2, 4 to 6, and Comparative Example 4, the insulation resistance was repeatedly measured for up to 1000 hours in order to confirm the change over time during the heat resistance evaluation period. In addition, for the magnetic bodies of Examples 1 and 2, and Comparative Example 1, the weight of the magnetic body was repeatedly measured for up to 1000 hours in order to confirm the change in weight during the heat resistance evaluation period. FIG. 3 shows a graph showing changes in insulation resistance over time. In addition, FIG. 4 shows a graph showing changes in weight over time.

TABLE 2
Measurement result immediately after production

| | Example 1 | Example 2 | Example 3 | Example 4 |
|---|---|---|---|---|
| Density | 5.50 | 5.42 | 5.57 | 5.46 |
| (g/cm³) | | | | |
| Relative | 24.7 | 23.4 | 27.6 | 25.2 |
| magnetic | | | | |
| permeability | | | | |
| Insulation | 2.13 × 10¹² | 1.48 × 10¹³ | 6.33 × 10¹² | 6.89 × 10¹¹ |
| resistance (Ω) | | | | |
| Radial crushing | 101.1 | 107.7 | 97.8 | 96.8 |
| strength (MPa) | | | | |

TABLE 3
Measurement result of storage after
1000 hours in environment of 180° C.

| | Example 1 | Example 2 | Example 3 | Example 4 |
|---|---|---|---|---|
| Insulation resistance (Ω) | 1.03 × 10⁸ | 1.11 × 10⁹ | 1.08 × 10⁹ | 8.02 × 10⁷ |
| Radial crushing strength | 77.5 | 73.4 | 59.8 | 33.7 |
| (MPa) | | | | |
| Strength retention rate | 76.7 | 68.2 | 61.1 | 34.8 |
| (%) | | | | |

TABLE 4
Measurement result immediately after production

| | Comparative | Comparative | Comparative |
|---|---|---|---|
| | Example 1 | Example 2 | Example 3 |
| Density (g/cm³) | 5.49 | 5.61 | 5.41 |
| Relative magnetic | 26.8 | 29.9 | 25.4 |
| permeability | | | |
| Insulation resistance (Ω) | 3.45 × 10⁶ | 1.68 × 10⁶ | 1.93 × 10⁶ |
| Radial crushing strength | 66.1 | 106 | 91.7 |
| (MPa) | | | |

TABLE 5
Measurement result of storage after
1000 hours in environment of 180° C.

| | Comparative | Comparative | Comparative |
|---|---|---|---|
| | Example 1 | Example 2 | Example 3 |
| Insulation resistance (Ω) | 2.98 × 10⁶ | 1.56 × 10⁶ | 8.27 × 10⁵ |
| Radial crushing strength | 57.2 | 17.8 | 44.0 |
| (MPa) | | | |
| Strength retention rate (%) | 86.5 | 16.8 | 48.0 |

TABLE 6

| | | | Comparative |
|---|---|---|---|
| | Example 5 | Example 6 | Example 4 |
| Density (g/cm3) | 5.34 | 5.32 | 5.55 |
| Relative magnetic | 24.2 | 22.2 | 22.0 |
| permeability | | | |
| Initial insulation resistance | 7.28 × 10¹² | 1.55 × 10¹³ | 8.90 × 10¹² |
| (Ω) | | | |
| Insulation resistance after | 1.02 × 10⁹ | 3.36 × 10⁹ | 1.00 × 10⁴ |
| 1000 hours (Ω) | | | |

For stable use in an environment of 180° C., it is preferable that the insulation resistance after 1000 hours is 10⁷Ω or more and the radial crushing strength is 30 MPa or more. Comparative Examples 1 to 3 do not have an insulating film, and therefore the insulation resistance is lower than that of Examples. Comparative Example 4 has an insulating film and thus has high insulation resistance at the initial stage. However, since Si is less than 4, the insulation resistance is remarkably lowered (FIG. 3). Comparative Example 1 has no insulating film, and thus the weight change is significant due to thermal decomposition of the resin cured product (FIG. 4).

The magnetic bodies of Examples 1 to 6 containing an iron alloy powder having an inorganic insulating layer on the surface and a resin cured product and containing 4 to 10 parts by mass of Si in 100 parts by mass of the iron alloy powder are shown to be excellent in heat resistance in terms of both insulation resistance and radial crushing strength. In particular, the magnetic bodies of Examples 1 to 3 having polyesterimide have a radial crushing strength of 50 MPa or more after being held in an environment of 180° C. for 1000 hours, indicating superior heat resistance.

This application claims priority based on Japanese Patent Application No. 2020-197987 filed on Nov. 30, 2020, the disclosure of which is entirely incorporated herein.

### REFERENCE SIGNS LIST

10 MAGNETIC BODY
11 COIL
12 TERMINAL PORTION
13 ADHESIVE MEMBER

1. A magnetic body, comprising:
an iron alloy powder having an inorganic insulating layer on a surface thereof; and
a resin cured product,
wherein the magnetic body contains 4 to 10 parts by mass of Si in 100 parts by mass of the iron alloy powder.

2. The magnetic body according to claim 1, wherein the resin cured product includes polyester imide.

3. The magnetic body according to claim 1, wherein the magnetic body has an insulation resistance of 10⁷Ω or more and a radial crushing strength of 30 MPa or more after being held in an environment of 180° C. for 1000 hours.

4. The magnetic body according to claim 1, wherein the inorganic insulating layer includes one or more selected from a phosphate salt and a silicate salt.

5. The magnetic body according to claim 1, wherein a proportion of the inorganic insulating layer is 0.1 to 3 parts by mass relative to 100 parts by mass of the iron alloy powder.

6. The magnetic body according to claim 1, wherein the iron alloy powder further includes one or more selected from Cr and Al.

7. The magnetic body according to claim 1, wherein an average particle size of the iron alloy powder is 5 to 30 m.

8. The magnetic body according to claim 1, wherein an average thickness of the inorganic insulating layer is 10 to 100 nm.

9. The magnetic body according to claim 1, wherein a proportion of the resin cured product is 2 to 6 parts by mass relative to 100 parts by mass of the iron alloy powder.

10. The magnetic body according to claim 1, wherein the resin cured product includes a cured product of a thermosetting resin composition containing a polyester-based resin, an epoxy-based resin, and a polyimide-based resin.

11. The magnetic body according to claim 10, wherein the polyester-based resin includes a carboxy group.

12. The magnetic body according to claim 10, wherein the polyimide-based resin includes an ethylenic double bond.

13. The magnetic body according to claim 10, wherein the thermosetting resin composition includes a peroxide.

14. A magnetic element, comprising:
the magnetic body according to claim 1; and
a coil embedded in the magnetic body.
